(19) United States
(12) Patent Application Publication
(10) Pub. No.: US 2026/0162390 A1
(43) Pub. Date: Jun. 11, 2026

(54) HEAD-MOUNTED DISPLAY, VIRTUAL OBJECT ADJUSTMENT METHOD, AND NON-TRANSITORY COMPUTER READABLE STORAGE MEDIUM THEREOF

(71) Applicant: HTC Corporation, Taoyuan City (TW)

(72) Inventor: Kuan-Wei LI, Taoyuan City (TW)

(21) Appl. No.: 18/976,251

(22) Filed: Dec. 10, 2024

(51) Int. Cl. G06T 19/20; G02B 27/01; G06F 3/01

(52) U.S. Cl. CPC G06T 19/20; G02B 27/017; G06F 3/013; G06F 3/014; G06T 2219/2021

(57) ABSTRACT

A head-mounted display, virtual object adjustment method, and non-transitory computer readable storage medium thereof are provided. The device determines whether there is at least one contact action located in at least one control area corresponding to a virtual object. In response to the at least one contact action being located in the at least one control area corresponding to the virtual object, the device calculates a displacement value of at least one indicator object. The device adjusts an appearance shape of the virtual object based on the displacement value of the at least one indicator object.

### BACKGROUND

### Field of Invention

The present invention relates to a head-mounted display, virtual object adjustment method, and non-transitory computer readable storage medium thereof. More particularly, the present invention relates to a head-mounted display, virtual object adjustment method, and non-transitory computer readable storage medium thereof that can efficiently adjust the appearance shape of a virtual object.

### Description of Related Art

In recent years, various technologies related to virtual reality, augmented reality, and mixed reality have developed rapidly, and various related technologies and applications have been proposed one after another.

In some application scenarios, users need to adjust the appearance shape of virtual objects displayed in the head-mounted display. In the prior art, the user must actively switch to the adjustment mode to adjust the virtual objects displayed in the head-mounted display (e.g., the user uses the controller to switch to the adjustment mode).

However, since the operation of switching to the adjustment mode requires the user to actively switch to the adjustment mode, the appearance shape of the virtual object cannot be adjusted efficiently, resulting in a poor user experience.

Accordingly, there is an urgent need for a virtual object adjustment technology that can efficiently adjust the appearance and shape of virtual objects.

### SUMMARY

An objective of the present disclosure is to provide a head-mounted display. The head-mounted display comprises a display, a user input tracking device, and a processor. The processor is electrically connected to the display and the user input tracking device. The display is configured to display a virtual object corresponding to a three-dimensional space in an image window. The user input tracking device is configured to track at least one indicator object operated by a user. The processor determines whether there is at least one contact action located in at least one control area corresponding to the virtual object, the contact action is generated by the at least one indicator object, and the at least one control area is close to at least one edge position of the virtual object. In response to having the at least one contact action located in the at least one control area corresponding to the virtual object, the processor calculates a displacement value of the at least one indicator object. The processor adjusts an appearance shape of the virtual object based on the displacement value of the at least one indicator object.

Another objective of the present disclosure is to provide a virtual object adjustment method, which is adapted for use in an electronic device. The electronic device comprises a display, a user input tracking device, and a processor. The display is configured to display a virtual object corresponding to a three-dimensional space in an image window. The user input tracking device is configured to track at least one indicator object operated by a user. The virtual object adjustment method comprises the following steps: determining whether there is at least one contact action located in at least one control area corresponding to the virtual object, wherein the contact action is generated by the at least one indicator object, and the at least one control area is close to at least one edge position of the virtual object; in response to having the at least one contact action located in the at least one control area corresponding to the virtual object, calculating a displacement value of the at least one indicator object; and adjusting an appearance shape of the virtual object based on the displacement value of the at least one indicator object.

A further objective of the present disclosure is to provide a non-transitory computer readable storage medium having a computer program stored therein. The computer program comprises a plurality of codes, the computer program executes a virtual object adjustment method after being loaded into an electronic device. The electronic device comprises a display, a user input tracking device, and a processor. The display is configured to display a virtual object corresponding to a three-dimensional space in an image window. The user input tracking device is configured to track at least one indicator object operated by a user. The virtual object adjustment method comprises the following steps: determining whether there is at least one contact action located in at least one control area corresponding to the virtual object, wherein the contact action is generated by the at least one indicator object, and the at least one control area is close to at least one edge position of the virtual object; in response to having the at least one contact action located in the at least one control area corresponding to the virtual object, calculating a displacement value of the at least one indicator object; and adjusting an appearance shape of the virtual object based on the displacement value of the at least one indicator object.

According to the above descriptions, the virtual object adjustment technology (at least including the head-mounted display, the method, and the non-transitory computer readable storage medium) provided by the present disclosure can actively determine whether there is a contact action located in the control area corresponding to the virtual object to determine whether to initiate the appearance shape adjustment operation. In addition, the virtual object adjustment technology provided by the present disclosure can adjust the appearance shape of the virtual object by calculating the displacement value of the at least one indicator object. Therefore, the virtual object adjustment technology provided by the present disclosure can directly adjust the virtual object without requiring the user to switch modes. Accordingly, the virtual object adjustment technology provided by the present disclosure can efficiently adjust the appearance and shape of virtual objects, solve the shortcomings of the existing technology, and improve the user's service experience.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic diagram depicting the head-mounted display of the first embodiment;

FIG. 2 is a schematic diagram depicting the head-mounted display of some embodiments;

FIG. 3 is a schematic diagram depicting the image window of some embodiments;

FIG. 4A is a schematic diagram depicting the adjustment of the virtual object of some embodiments;

FIG. 4B is a schematic diagram depicting the adjustment of the virtual object of some embodiments;

FIG. 5A is a schematic diagram depicting the adjustment of the virtual object of some embodiments;

FIG. 5B is a schematic diagram depicting the adjustment of the virtual object of some embodiments;

FIG. 6A is a schematic diagram depicting the adjustment of the virtual object of some embodiments;

FIG. 6B is a schematic diagram depicting the adjustment of the virtual object of some embodiments;

FIG. 7A is a schematic diagram depicting the adjustment of the virtual object of some embodiments;

FIG. 7B is a schematic diagram depicting the adjustment of the virtual object of some embodiments;

FIG. 8A-8D are schematic diagrams depicting the adjustment of the virtual object of some embodiments; and

FIG. 9 is a partial flowchart depicting the virtual object adjustment method of the second embodiment.

### DETAILED DESCRIPTION

In the following description, a head-mounted display, virtual object adjustment method, and non-transitory computer readable storage medium thereof according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

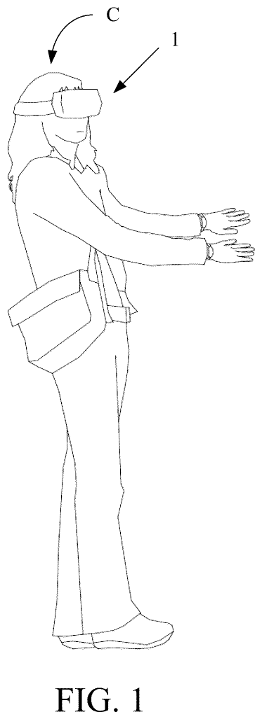

First, the applicable scene of the present embodiment will be described, and a schematic diagram of which is depicted in FIG. 1. As shown in FIG. 1, in the application environment of the present disclosure, the user C uses the head-mounted display 1, and the user C may perform interactive operation to the image window of the head-mounted display 1 through finger operations (e.g., the gesture) or controllers.

In some embodiments, the head-mounted display 1 can be a VR/MR/AR head-mounted device. The head-mounted display 1 can allow the user C to see the hands or the controller operated by the user C through optical see-through or video see-through.

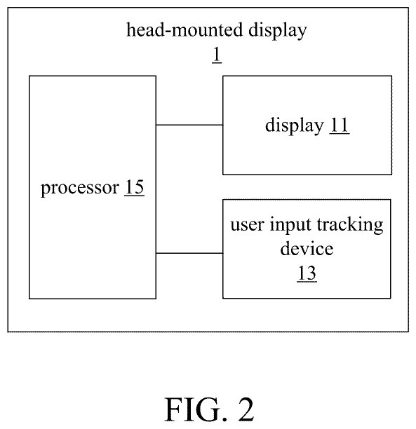

In the present embodiment, a schematic diagram of the structure of the head-mounted display 1 is depicted in FIG. 2. The head-mounted display 1 comprises a display 11, a user input tracking device 13, and a processor 15. The processor 15 is electrically connected to the display 11 and the user input tracking device 13.

It shall be appreciated that the display 11 can be any devices with display functions. The user input tracking device 13 may be any device with a function of tracking user input. For example, the user input tracking device 13 can be used to track one or more fingers of the user C (for example: gesture tracking), the projection ray operated by the user C, the eyeball trajectory of the user C, or the controller operated by the user C.

Specifically, the user input tracking device 13 can be implemented through one of an inside-out image capturing device, an outside-in image capturing device, an inertial measurement unit, or a combination thereof.

It shall be appreciated that the user input tracking device 13 can continuously generate a sequence of multiple tracking data (for example: a tracking data stream generated at a frequency of 1000 times per second). During operation, the processor 15 may periodically receive the tracking data from the user input tracking device 13.

For example, the user input tracking device 13 may be an image capturing device including a plurality of image capturing units (e.g., a plurality of depth camera lenses) to generate a plurality of real-time images corresponding to a field of view (FOV). For another example, the image capturing unit can be disposed at different positions such as the bottom or the front of the head-mounted display 1 to obtain real-time images in different fields of view.

In some embodiments, the user input tracking device 13 can assist in tracking the user's input by combining tracking data generated by an external device (such as inertial sensing data of external devices, real-time images generated by external devices, etc.).

The processor 15 may be any of various processors, Central Processing Units (CPUs), microprocessors, digital signal processors or other computing apparatuses known to those of ordinary skill in the art.

In the present embodiment, the display 11 is configured to display a virtual object corresponding to a three-dimensional space in an image window, and the user input tracking device 13 is configured to track the input of the user C (e.g., tracking through multiple real-time images of one or more fingers of the user C, or tracking through inertial sensing data generated by a controller operated by the user C). It shall be appreciated that for ease of explanation, in some embodiments of the present disclosure, at least one indicator object is one or more fingers of the user C or a controller operated by the user C. In the present embodiment, the user input tracking device 13 is configured to track at least one indicator object operated by the user C.

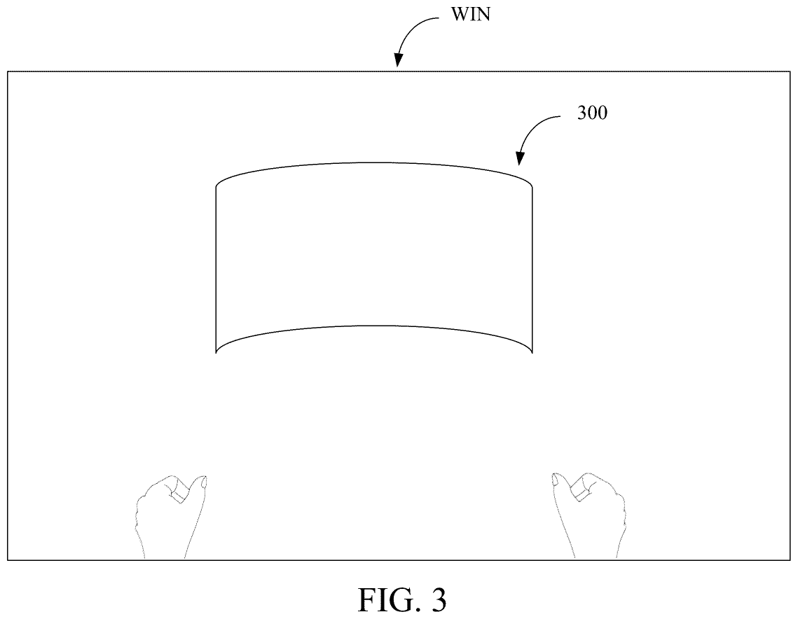

For example, as shown in FIG. 3, the display 11 of the head-mounted display 1 can be used to display the image window WIN, and the image window WIN includes the virtual object 300. In some embodiments, the user C can also view user C's hand or the controller (i.e., at least one indicator object) operated by the user C through the image window WIN.

It shall be appreciated that FIG. 3 is merely an example for illustration, and the present disclosure does not limit the content of the image window WIN. For example, the image window WIN may include a plurality of virtual objects, depending on the actual application requirements of the head-mounted display 1.

In the present embodiment, the processor 15 determines whether there is at least one contact action located in at least one control area corresponding to the virtual object 300. It shall be appreciated that the aforementioned contact action is generated by the at least one indicator object, and the at least one control area is close to at least one edge position of the virtual object 300.

For example, if the virtual object 300 is a quadrilateral with four edges, the processor 15 can set a position close to the four edges as a control area (e.g., extend a 5 mm range outward from the four edges of the virtual object).

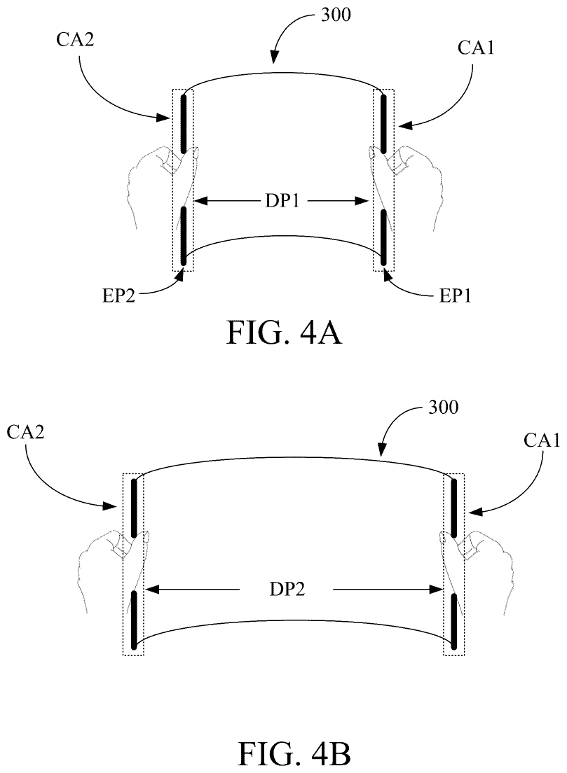

For ease of understanding, please refer to FIG. 4A. In the present example, the processor 15 sets the area located near the first edge position EP1 of the virtual object 300 as the control area CA1, and the processor 15 sets the area located near the second edge position EP2 of the virtual object 300 as the control area CA2. In the present example, the processor 15 determines that there is a contact action (i.e., a direct touch of the hand) located in the control area CA1 and the control area CA2.

Next, in the present embodiment, in response to having the at least one contact action located in the at least one control area corresponding to the virtual object 300, the processor 15 calculates a displacement value of the at least one indicator object.

Finally, the processor 15 adjusts an appearance shape of the virtual object 300 based on the displacement value of the at least one indicator object.

For ease of understanding, please refer to FIG. 4A and FIG. 4B. As shown in FIG. 4B, the indicator objects move in the outward direction of the virtual object 300 (e.g., the user C's left and right hands move outward). The processor 15 may calculate the displacement value of the indicator objects based on the distance DP1 between the indicator objects before movement and the distance DP2 between the indicator objects after movement. In the present example, the processor 15 expands the appearance shape of the virtual object 300 outward based on the displacement value of the indicator objects.

It shall be appreciated that the term “contact action” defined in the present disclosure includes that the user C has actually contacted the control area through an object (such as a hand or a controller) or that a projection ray operated by the user C has indirectly contacted the control area.

In some embodiments, when the distance between the user C and the virtual object 300 is relatively far, the user C does not need to trigger the adjustment operation by actually touching the control area. For example, the user C can trigger the adjustment operation of the virtual object 300 through projection rays (e.g., infrared rays) emitted by gestures or the controller.

Specifically, the processor 15 calculates a projection trajectory of a projection ray emitted by the at least one indicator object. Next, the processor 15 determines whether the projection trajectory is located in the at least one control area corresponding to the virtual object 300. Finally, in response to the projection trajectory being located in the at least one control area corresponding to the virtual object 300, the processor 15 determines there is the at least one contact action located in the at least one control area corresponding to the virtual object 300.

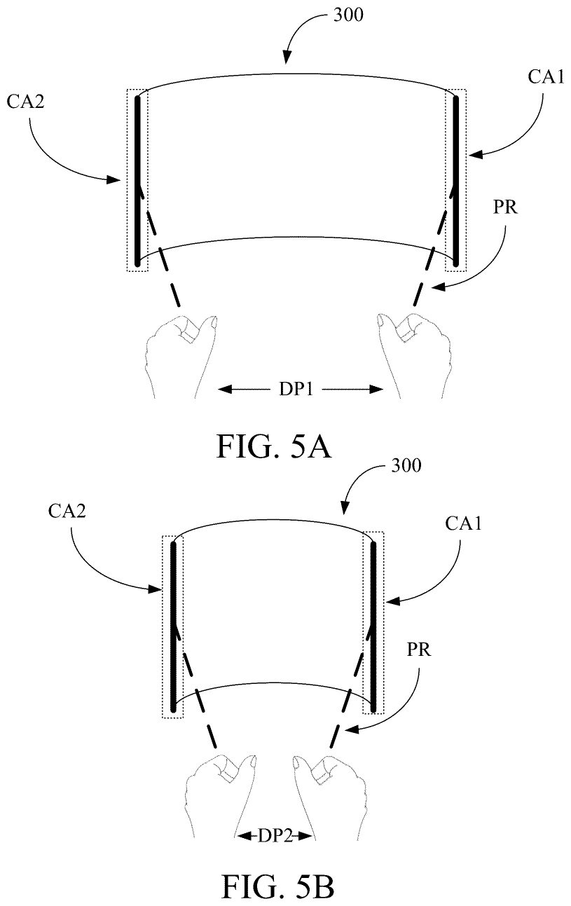

For ease of understanding, please refer to FIG. 5A and FIG. 5B. As shown in FIG. 5A, the processor 15 determines that the projection rays PR projected by the gestures of the user C are located in the control area CA1 and the control area CA2 corresponding to the virtual object 300. As shown in FIG. 5B, the indicator objects move in the inward direction of the virtual object 300 respectively (e.g., the left and right hands of the user C move inward). In the present example, the processor 15 can calculate the displacement value of the indicator objects based on the distance DP1 between the indicator objects before movement and the distance DP2 between the indicator objects after movement. In the present example, the processor 15 shrinks the appearance shape of the virtual object 300 inwards based on the displacement value of the indicator objects.

In some embodiments, in addition to determining that the at least one contact action is located in at least one control area corresponding to the virtual object, the processor 15 can further determine whether there is a selection action to confirm that the user C wants to perform adjustment operations. For example, the processor 15 can determine whether there is a selection action by determining whether the user C presents the target gesture.

In some embodiments, the at least one indicator object is at least one finger that conforms to a target gesture. For example, the target gesture may be a target gesture of extending the index finger, a target gesture of pinching with the index finger and thumb open, a target gesture of grasping with an open palm, etc.

In some embodiments, the at least one indicator object may be at least one controller operated by the user C. In some embodiments, the controller may have physical buttons for the user C to perform selection actions.

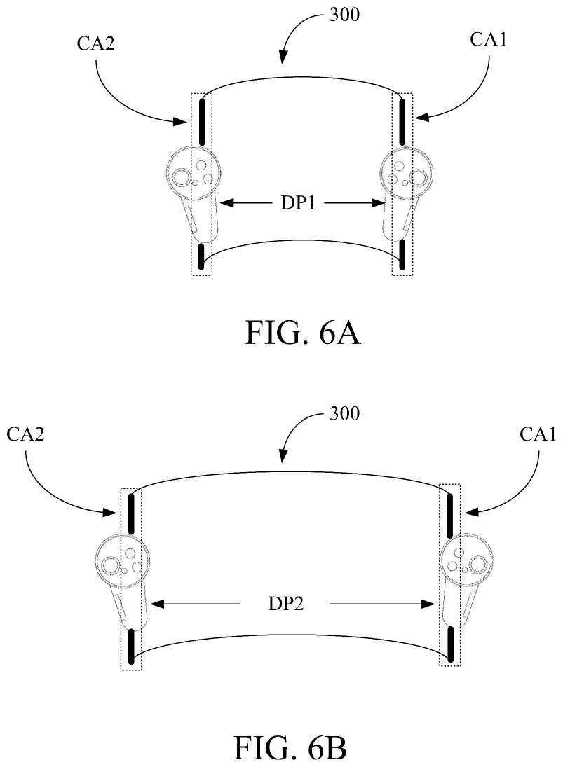

For ease of understanding, please refer to FIG. 6A and FIG. 6B. As shown in FIG. 6A, the processor 15 determines that at least one controller operated by the user C is located in the control area CA1 and the control area CA2 corresponding to the virtual object 300. As shown in FIG. 6B, the indicator objects move in the outward direction of the virtual object 300 respectively. In the present example, the processor 15 can calculate the displacement value of the indicator objects based on the distance DP1 between the indicator objects before movement and the distance DP2 between the indicator objects after movement. In the present example, the processor 15 expands the appearance shape of the virtual object 300 outward based on the displacement value of the indicator objects.

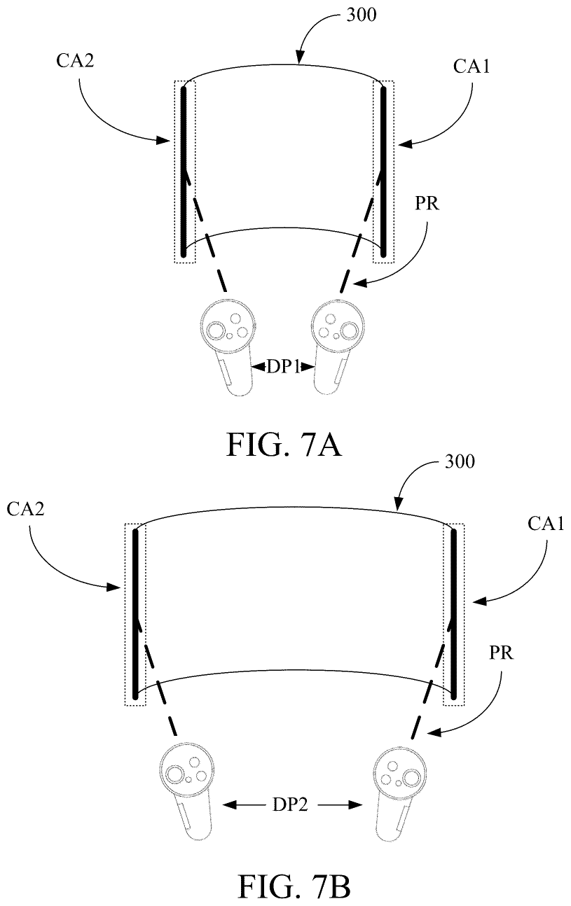

For another example, as shown in FIG. 7A and FIG. 7B. The appearance shape of the virtual object 300 can be adjusted through the projection ray PR projected by the controller operated by the user C.

In some embodiments, the operation of the processor 15 to adjust the appearance shape of the virtual object 300 includes adjusting the curvature of the virtual object 300. Specifically, the processor 15 calculates a curvature corresponding to the virtual object 300 based on the displacement value of the at least one indicator object. Then, the processor 15 adjusts the appearance shape of the virtual object 300 based on the curvature corresponding to the virtual object 300.

For example, the processor 15 can calculate the curvature through the following equation.

$$\{ \begin{matrix}DP = {DP}_{0} + k * Δ DH \\ {D}_{min} \leq DP \leq {D}_{max}\end{matrix}$$

The parameter DP refers to the distance between the left edge and the right edge of the virtual object. The curvature of the virtual object is controlled by the parameter DP. The DP is limited to a preset interval to avoid exceeding the maximum or minimum curvature range. The parameter DP₀ is the initial distance, the parameter ΔDH is the displacement value, and the parameter k is a number greater than 0 (between 0 and 1). When the size of the virtual object is larger, the parameter k can be set higher. In addition, when the distance between the virtual object and the user is farther, the parameter k can be set higher.

In addition, the curvature of virtual objects can be set through different curvature change relationships. For example: the long side of the virtual object is part of an arc, the long side of the virtual object is part of an elliptical arc, the long side of the virtual object is part of a parabola, and the curvature of the virtual object is calculated based on the elastic properties of the virtual object.

In some embodiments, in order to make the adjustment determination of the virtual object 300 more accurate, the head-mounted display 1 can further add the eye movement of the user C as one of the determination conditions. For example, the head-mounted display 1 can generate a plurality of eye trajectories corresponding to the user C by setting an eye tracker or an internal image capturing device.

Specifically, the processor 15 calculates an eye gaze position in the image window of the user C at each of a plurality time points based on the eyeball trajectory of the user C. Then, the processor 15 determines whether to perform the operation of determining whether there is the at least one contact action located in the at least one control area corresponding to the virtual object 300 based on the eye gaze positions.

In some embodiments, the user C starts the adjustment operation only when the eye gaze position of the user C is located in the control area. Specifically, in response to the eye gaze position being located in the at least one control area, the processor 15 determines whether there is the at least one contact action located in the at least one control area corresponding to the virtual object 300.

In some embodiments, in order to save computing resources, when the eye gaze position of the user C is not in the control area, the adjustment operation is not started. Specifically, in response to the eye gaze position not being located in the at least one control area, the processor 15 stops to determine whether there is the at least one contact action located in the at least one control area corresponding to the virtual object 300.

In some embodiments, the processor 15 can perform segmented determination on the control areas at different time points. Specifically, in response to the eye gaze position being located at a first edge position of the at least one edge position at a first time point, the processor 15 determines whether a first contact action is located in a first control area of the at least one control area, wherein the first control area is close to the first edge position. Next, in response to the eye gaze position being located at a second edge position of the at least one edge position at a second time point, the processor 15 determines whether a second contact action is located in a second control area of the at least one control area, wherein the second control area is close to the second edge position. Finally, in response to the first contact action being located in the first control area and the second contact action being located in the second control area, the processor 15 calculates the displacement value of the at least one indicator object.

In some embodiments, the first edge position may be a first control area, and the second edge position may be a second control area.

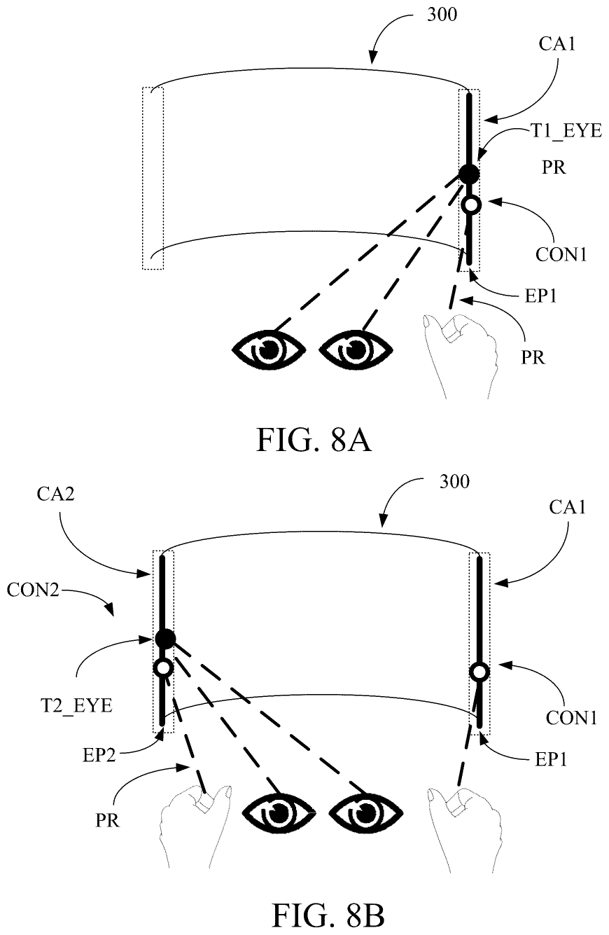

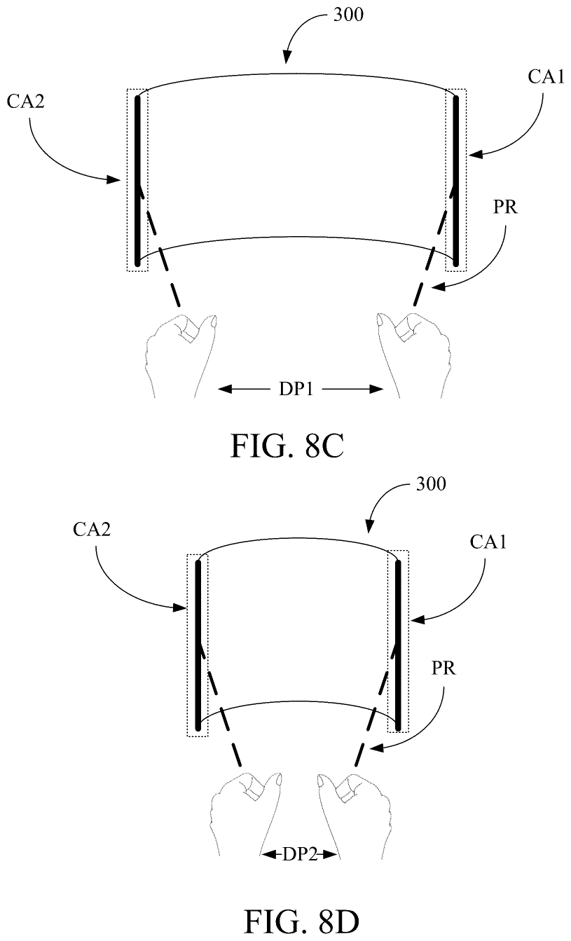

For ease of understanding, please refer to the operation diagrams FIGS. 8A, 8B, 8C, and 8D. It shall be appreciated that the following uses the projection ray projected by the user C through gestures for remote control as an example. In other examples, it can also be implemented in other ways, such as: the controller operated by the user C, the projection ray projected by the controller operated by the user C, the hand of the user C, etc.

In the present example, as shown in FIG. 8A, the processor 15 first determines whether the eye gaze position T1_EYE is located at the first edge position EP1 of the virtual object 300. Next, in response to the eye gaze position T1_EYE at the first time point being located at the first edge position EP1, the processor 15 determines whether the first contact action CON1 is located in the first control area CA1 (for example: the projection ray cast by the right hand gesture of the user C). In the present example, the projection ray projected by the gesture of the right hand of the user C is located in the first control area CA1, so the processor 15 continues to perform subsequent operations.

Next, as shown in FIG. 8B, the processor 15 first determines whether the eye gaze position T2_EYE is located at the second edge position EP2 of the virtual object 300. Then, in response to the eye gaze position T2_EYE at the second time point being located at the second edge position EP2, the processor 15 determines whether the second contact action CON2 is located in the second control area CA2 (for example: the projection ray cast by the left hand gesture of the user C). In the present example, the projection ray projected by the gesture of the left hand of the user C is located in the first control area CA2, so the processor 15 continues to perform subsequent adjustment judgment operations.

Then, in response to the left and right control areas of the virtual object 300 being selected, the processor 15 can adjust the appearance shape of the virtual object 300 by determining the positions of the left and right hands of the user C. In the present example, as shown in FIGS. 8C and 8D, the processor 15 can calculate the displacement value of the indicator objects based on the distance DP1 between the the indicator objects before movement and the distance DP2 between the indicator objects after movement.

In some embodiments, the virtual object 300 is a display panel, and the display panel is configured to display a multimedia content. Based on an adjusted appearance shape (e.g., a virtual object with adjusted curvature), the processor 15 generates the multimedia content corresponding to the adjusted appearance shape.

In some embodiments, the control area can provide eye-catching reminders by emitting light. In addition, the processor 15 can prompt the user C that the at least one indicator object is located in the control area through various mechanisms. For example, the processor 15 can respectively provide reminders about “near the control area”, “located in the control area”, and “adjustment operation started” through feedback mechanisms such as different light colors, sounds, vibrations, etc.

According to the above descriptions, the head-mounted display 1 provided by the present disclosure can actively determine whether there is a contact action located in the control area corresponding to the virtual object to determine whether to initiate the appearance shape adjustment operation. In addition, the head-mounted display 1 provided by the present disclosure can adjust the appearance shape of the virtual object by calculating the displacement value of the at least one indicator object. Therefore, the head-mounted display 1 provided by the present disclosure can directly adjust the virtual object without requiring the user to switch modes. Accordingly, the head-mounted display 1 provided by the present disclosure can efficiently adjust the appearance and shape of virtual objects, solve the shortcomings of the existing technology, and improve the user's service experience.

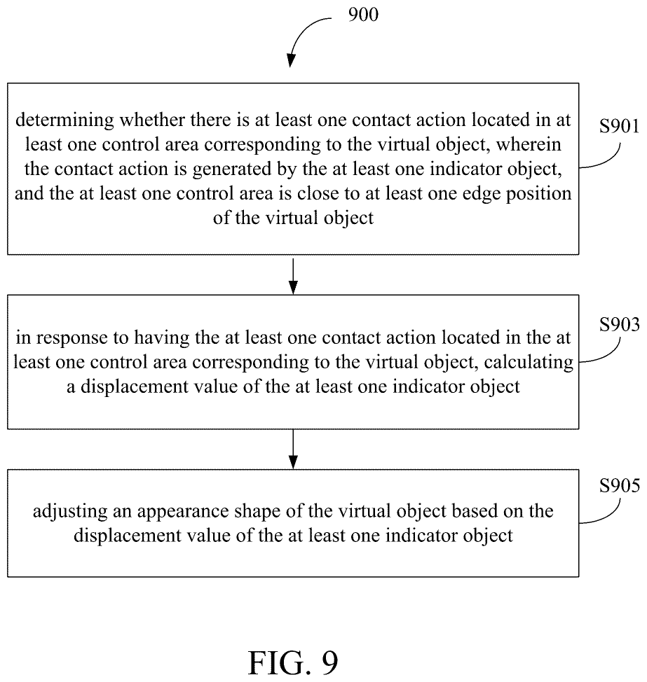

A second embodiment of the present disclosure is a virtual object adjustment method and a flowchart thereof is depicted in FIG. 9. The virtual object adjustment method 900 is adapted for an electronic device (e.g., the head-mounted display 1 described in the first embodiment). The electronic device comprises a display, a user input tracking device, and a processor. The display is configured to display a virtual object corresponding to a three-dimensional space in an image window (e.g., the display 11 described in the first embodiment). The user input tracking device is configured to track at least one indicator object operated by a user (e.g., the user input tracking device 13 described in the first embodiment). The virtual object adjustment method 900 adjusts an appearance shape of the virtual object through the steps S901 to S905.

In the step S901, the electronic device determines whether there is at least one contact action located in at least one control area corresponding to the virtual object, wherein the contact action is generated by the at least one indicator object, and the at least one control area is close to at least one edge position of the virtual object.

Next, in the step S903, in response to having the at least one contact action located in the at least one control area corresponding to the virtual object, the electronic device calculates a displacement value of the at least one indicator object.

Finally, in the step S905, the electronic device adjusts an appearance shape of the virtual object based on the displacement value of the at least one indicator object.

In some embodiments, wherein the step of determining whether there is the at least one contact action located in the at least one control area corresponding to the virtual object further comprises the following steps: calculating a projection trajectory of a projection ray emitted by the at least one indicator object; determining whether the projection trajectory is located in the at least one control area corresponding to the virtual object; and in response to the projection trajectory being located in the at least one control area corresponding to the virtual object, determining there is the at least one contact action located in the at least one control area corresponding to the virtual object.

In some embodiments, wherein the at least one indicator object is at least one controller operated by the user.

In some embodiments, wherein the at least one indicator object is at least one finger corresponding to a target gesture.

In some embodiments, wherein the step of adjusting the appearance shape of the virtual object further comprises the following steps: calculating a curvature corresponding to the virtual object based on the displacement value of the at least one indicator object; and adjusting the appearance shape of the virtual object based on the curvature corresponding to the virtual object.

In some embodiments, wherein the virtual object adjustment method 900 further comprises the following steps: calculating, based on an eyeball trajectory of the user, an eye gaze position in the image window of the user at each of a plurality time points; and determining whether to perform the step of determining whether there is the at least one contact action located in the at least one control area corresponding to the virtual object based on the eye gaze positions.

In some embodiments, wherein the step of determining whether to perform the step of determining whether there is the at least one contact action located in the at least one control area corresponding to the virtual object comprises the following steps: in response to the eye gaze position being located in the at least one control area, determining whether there is the at least one contact action located in the at least one control area corresponding to the virtual object.

In some embodiments, wherein the virtual object adjustment method 900 further comprises the following steps: in response to the eye gaze position being located at a first edge position of the at least one edge position at a first time point, determining whether a first contact action is located in a first control area of the at least one control area, wherein the first control area is close to the first edge position; in response to the eye gaze position being located at a second edge position of the at least one edge position at a second time point, determining whether a second contact action is located in a second control area of the at least one control area, wherein the second control area is close to the second edge position; and in response to the first contact action being located in the first control area and the second contact action being located in the second control area, calculating the displacement value of the at least one indicator object.

In some embodiments, wherein the step of determining whether to perform the step of determining whether there is the at least one contact action located in the at least one control area corresponding to the virtual object comprises the following steps: in response to the eye gaze position not being located in the at least one control area, stopping to determine whether there is the at least one contact action located in the at least one control area corresponding to the virtual object.

In addition to the aforesaid steps, the second embodiment can also execute all the operations and steps of the head-mounted display 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The virtual object adjustment method described in the second embodiment may be implemented by a computer program having a plurality of codes. The computer program may be a file that can be transmitted over the network, or may be stored into a non-transitory computer readable storage medium. After the codes of the computer program are loaded into an electronic device (e.g., the head-mounted display 1), the computer program executes the virtual object adjustment method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

It shall be appreciated that in the specification and the claims of the present disclosure, some words (e.g., time point, edge position, contact action, control area, etc.) are preceded by terms such as “first”, or “second”, and these terms of “first”, or “second” are only used to distinguish these different words. For example, the “first” resolution and the “second” control area are only used to indicate the control area used in different operations.

According to the above descriptions, the virtual object adjustment technology (at least including the head-mounted display, the method, and the non-transitory computer readable storage medium) provided by the present disclosure can actively determine whether there is a contact action located in the control area corresponding to the virtual object to determine whether to initiate the appearance shape adjustment operation. In addition, the virtual object adjustment technology provided by the present disclosure can adjust the appearance shape of the virtual object by calculating the displacement value of the at least one indicator object. Therefore, the virtual object adjustment technology provided by the present disclosure can directly adjust the virtual object without requiring the user to switch modes. Accordingly, the virtual object adjustment technology provided by the present disclosure can efficiently adjust the appearance and shape of virtual objects, solve the shortcomings of the existing technology, and improve the user's service experience.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A head-mounted display, comprising:
a display, being configured to display a virtual object corresponding to a three-dimensional space in an image window;
a user input tracking device, being configured to track at least one indicator object operated by a user; and
a processor, being electrically connected to the display and the user input tracking device, and being configured to perform the operations comprising:
determining whether there is at least one contact action located in at least one control area corresponding to the virtual object, wherein the contact action is generated by the at least one indicator object, and the at least one control area is close to at least one edge position of the virtual object;
in response to having the at least one contact action located in the at least one control area corresponding to the virtual object, calculating a displacement value of the at least one indicator object; and
adjusting an appearance shape of the virtual object based on the displacement value of the at least one indicator object.

2. The head-mounted display of claim 1, wherein the operation of determining whether there is the at least one contact action located in the at least one control area corresponding to the virtual object further comprises the following operations:
calculating a projection trajectory of a projection ray emitted by the at least one indicator object;
determining whether the projection trajectory is located in the at least one control area corresponding to the virtual object; and
in response to the projection trajectory being located in the at least one control area corresponding to the virtual object, determining there is the at least one contact action located in the at least one control area corresponding to the virtual object.

3. The head-mounted display of claim 1, wherein the at least one indicator object is at least one controller operated by the user.

4. The head-mounted display of claim 1, wherein the at least one indicator object is at least one finger corresponding to a target gesture.

5. The head-mounted display of claim 1, wherein the operation of adjusting the appearance shape of the virtual object further comprises the following operations:
calculating a curvature corresponding to the virtual object based on the displacement value of the at least one indicator object; and
adjusting the appearance shape of the virtual object based on the curvature corresponding to the virtual object.

6. The head-mounted display of claim 1, wherein the processor further performs the following operations:
calculating, based on an eyeball trajectory of the user, an eye gaze position in the image window of the user at each of a plurality time points; and
determining whether to perform the operation of determining whether there is the at least one contact action located in the at least one control area corresponding to the virtual object based on the eye gaze positions.

7. The head-mounted display of claim 6, wherein the operation of determining whether to perform the operation of determining whether there is the at least one contact action located in the at least one control area corresponding to the virtual object comprises the following operations:
in response to the eye gaze position being located in the at least one control area, determining whether there is the at least one contact action located in the at least one control area corresponding to the virtual object.

8. The head-mounted display of claim 7, wherein the processor further performs the following operations:
in response to the eye gaze position being located at a first edge position of the at least one edge position at a first time point, determining whether a first contact action is located in a first control area of the at least one control area, wherein the first control area is close to the first edge position;
in response to the eye gaze position being located at a second edge position of the at least one edge position at a second time point, determining whether a second contact action is located in a second control area of the at least one control area, wherein the second control area is close to the second edge position; and
in response to the first contact action being located in the first control area and the second contact action being located in the second control area, calculating the displacement value of the at least one indicator object.

9. The head-mounted display of claim 6, wherein the operation of determining whether to perform the operation of determining whether there is the at least one contact action located in the at least one control area corresponding to the virtual object comprises the following operations:
in response to the eye gaze position not being located in the at least one control area, stopping to determine whether there is the at least one contact action located in the at least one control area corresponding to the virtual object.

10. The head-mounted display of claim 1, wherein the virtual object is a display panel, the display panel is configured to display a multimedia content, and the processor further performs the following operations:
generating, based on an adjusted appearance shape, the multimedia content corresponding to the adjusted appearance shape.

11. A virtual object adjustment method, being adapted for use in an electronic device, wherein the electronic device comprises a display, a user input tracking device, and a processor, the display is configured to display a virtual object corresponding to a three-dimensional space in an image window, the user input tracking device is configured to track at least one indicator object operated by a user, and the virtual object adjustment method comprises:
determining whether there is at least one contact action located in at least one control area corresponding to the virtual object, wherein the contact action is generated by the at least one indicator object, and the at least one control area is close to at least one edge position of the virtual object;
in response to having the at least one contact action located in the at least one control area corresponding to the virtual object, calculating a displacement value of the at least one indicator object; and
adjusting an appearance shape of the virtual object based on the displacement value of the at least one indicator object.

12. The virtual object adjustment method of claim 11, wherein the step of determining whether there is the at least one contact action located in the at least one control area corresponding to the virtual object further comprises the following steps:
calculating a projection trajectory of a projection ray emitted by the at least one indicator object;
determining whether the projection trajectory is located in the at least one control area corresponding to the virtual object; and
in response to the projection trajectory being located in the at least one control area corresponding to the virtual object, determining there is the at least one contact action located in the at least one control area corresponding to the virtual object.

13. The virtual object adjustment method of claim 11, wherein the at least one indicator object is at least one controller operated by the user.

14. The virtual object adjustment method of claim 11, wherein the at least one indicator object is at least one finger corresponding to a target gesture.

15. The virtual object adjustment method of claim 11, wherein the step of adjusting the appearance shape of the virtual object further comprises the following steps:
calculating a curvature corresponding to the virtual object based on the displacement value of the at least one indicator object; and
adjusting the appearance shape of the virtual object based on the curvature corresponding to the virtual object.

16. The virtual object adjustment method of claim 11, wherein the virtual object adjustment method further comprises the following steps:
calculating, based on an eyeball trajectory of the user, an eye gaze position in the image window of the user at each of a plurality time points; and
determining whether to perform the step of determining whether there is the at least one contact action located in the at least one control area corresponding to the virtual object based on the eye gaze positions.

17. The virtual object adjustment method of claim 16, wherein the step of determining whether to perform the step of determining whether there is the at least one contact action located in the at least one control area corresponding to the virtual object comprises the following steps:
in response to the eye gaze position being located in the at least one control area, determining whether there is the at least one contact action located in the at least one control area corresponding to the virtual object.

18. The virtual object adjustment method of claim 17, wherein the virtual object adjustment method further comprises the following steps:
in response to the eye gaze position being located at a first edge position of the at least one edge position at a first time point, determining whether a first contact action is located in a first control area of the at least one control area, wherein the first control area is close to the first edge position;
in response to the eye gaze position being located at a second edge position of the at least one edge position at a second time point, determining whether a second contact action is located in a second control area of the at least one control area, wherein the second control area is close to the second edge position; and
in response to the first contact action being located in the first control area and the second contact action being located in the second control area, calculating the displacement value of the at least one indicator object.

19. The virtual object adjustment method of claim 16, wherein the step of determining whether to perform the step of determining whether there is the at least one contact action located in the at least one control area corresponding to the virtual object comprises the following steps:
in response to the eye gaze position not being located in the at least one control area, stopping to determine whether there is the at least one contact action located in the at least one control area corresponding to the virtual object.

20. A non-transitory computer readable storage medium, having a computer program stored therein, wherein the computer program comprises a plurality of codes, the computer program executes a virtual object adjustment method after being loaded into an electronic device, the electronic device comprises a display, a user input tracking device, and a processor, the display is configured to display a virtual object corresponding to a three-dimensional space in an image window, the user input tracking device is configured to track at least one indicator object operated by a user, and the virtual object adjustment method comprises:
determining whether there is at least one contact action located in at least one control area corresponding to the virtual object, wherein the contact action is generated by the at least one indicator object, and the at least one control area is close to at least one edge position of the virtual object;
in response to having the at least one contact action located in the at least one control area corresponding to the virtual object, calculating a displacement value of the at least one indicator object; and
adjusting an appearance shape of the virtual object based on the displacement value of the at least one indicator object.
